(19) United States
(12) Patent Application Publication
(10) Pub. No.: US 2024/0271468 A1
(43) Pub. Date: Aug. 15, 2024

(54) LATCH WITH MONODIRECTIONAL RELEASE/RESET

(71) Applicant: MAGNA CLOSURES INC., Newmarket (CA)

(72) Inventor: Francesco BIASCI, Tuscany (IT)

(21) Appl. No.: 18/435,884

(22) Filed: Feb. 7, 2024

Related U.S. Application Data
(60) Provisional application No. 63/444,796, filed on Feb. 10, 2023.

(51) Int. Cl. E05B 81/22; E05B 81/06; E05B 81/34

(52) U.S. Cl. CPC E05B 81/22; E05B 81/06; E05B 81/34

(57) ABSTRACT

A power latch assembly for a motor vehicle includes a pawl moveable from a ratchet holding position, whereat a ratchet is maintained in a striker capture position, whereat the ratchet is in latched engagement with a striker to maintain a closure panel in a closed position, to a ratchet releasing position, whereat the ratchet is moved to a striker release position out of latched engagement from the striker to allow the closure panel to be moved from the closed position to the open position. Further included is a power release actuator arranged to move a power release gear in a first direction from a rest position, whereat the pawl is in the ratchet holding position, to a first release actuated position, whereat the pawl is moved to the ratchet releasing position, and to move the power release gear from the first release actuated position in the first direction to a first reset actuated position, whereat the pawl is free to return to the ratchet holding position.

### CROSS-REFERENCE TO RELATED APPLICATION

This application claims the benefit of U.S. Provisional Application Ser. No. 63/444,796, filed Feb. 10, 2023, which is incorporated herein by reference in its entirety.

### FIELD

The present disclosure relates generally to power closure panel systems for motor vehicles. More particularly, the present disclosure is directed to a power latch assembly operable for powered holding and powered releasing of a ratchet relative to a pawl of the power latch assembly.

### BACKGROUND

This section provides background information related to the present disclosure which is not necessarily prior art.

In view of increased consumer demand for motor vehicles equipped with advanced comfort and convenience features, many current vehicles are now provided with power actuated latch assemblies operable via passive keyless entry systems to permit powered locking and powered release of the latch assembles without the use of traditional manual entry mechanisms. Although such power actuated latch assemblies provide desired functionality, further advancements are desired to ensure features of the power actuated latch assemblies attain their intended position and functionality, while operating in an efficient, quick and reliable manner, while producing minimal noise.

In view of the above, there remains a desire to develop alternative power door latch assemblies which address and overcome limitations associated with known power door latch assemblies to provide enhanced functionality and operational efficiency, while minimizing noise in operation and minimizing cost and complexity associated with such advancements.

### SUMMARY

This section provides a general summary of the present disclosure and is not a comprehensive disclosure of its full scope or all of its features, aspects and objectives.

It is an aspect of the present disclosure to provide a latch assembly for selectively unlatching a vehicle closure panel for desired movement of the closure panel from a closed position to an open or deployed positions relative to a vehicle body when desired and for retaining the closure panel in a closed position and at least partially closed position relative to the vehicle body when desired via actuation of a power release actuator for movement of a power release gear in a single direction.

It is a further aspect of the present disclosure to optimize the efficiency of movement of components of the power latch assembly during movement between operational positions.

It is a further aspect of the present disclosure to minimize noise generated by the power latch assembly during movement of components between operational positions.

In accordance with these and other aspects, a power latch assembly for a motor vehicle includes a pawl moveable from a ratchet holding position, whereat a ratchet is maintained in a striker capture position, whereat the ratchet is in latched engagement with a striker to maintain a closure panel in a closed position, to a ratchet releasing position, whereat the ratchet is moved to a striker release position out of latched engagement from the striker to allow the closure panel to be moved from the closed position to the open position. Further included is a power release actuator arranged to move a power release gear in a first direction from a rest position, whereat the pawl is in the ratchet holding position, to a first release actuated position, whereat the pawl is moved to the ratchet releasing position, and to move the power release gear from the first release actuated position in the first direction to a first reset actuated position, whereat the pawl is free to return to the ratchet holding position.

In accordance with another aspect of the disclosure, the power release gear moves in the first direction about 180 degrees or less from the rest position to the first reset actuated position.

In accordance with another aspect of the disclosure, the power release actuator is arranged to move the power release gear from the first reset actuated position, whereat the pawl is in the ratchet holding position, in the first direction to a second release actuated position, whereat the pawl is moved to the ratchet releasing position.

In accordance with another aspect of the disclosure, the power release gear has a first pawl release cog configured to engage the pawl when in the first release actuated position and a second pawl release cog configured to engage the pawl when in the second release actuated position, wherein the first pawl release cog and the second pawl release cog are circumferentially offset from one another.

In accordance with another aspect of the disclosure, the power release actuator is arranged to move the power release gear from the second release actuated position in the first direction to a second reset actuated position, whereat the pawl is free to return to the ratchet holding position.

In accordance with another aspect of the disclosure, the power release actuator is arranged to move the power release gear from the second release actuated position, in the first direction, to a second snow load actuated position, whereat the pawl is prevented from returning to the ratchet holding position.

In accordance with another aspect of the disclosure, the power release gear is configured to trigger a second snow load sensor to indicate when the power release gear is in the second snow load actuated position.

In accordance with another aspect of the disclosure, the power release actuator is arranged to move the power release gear from the first release actuated position, in the first direction, to a first snow load actuated position, whereat the pawl is prevented from returning to the ratchet holding position.

In accordance with another aspect of the disclosure, the power release actuator is arranged to move the power release gear from the first snow load actuated position in the first direction to the first reset actuated position.

In accordance with another aspect of the disclosure, a power latch assembly for a motor vehicle includes a pawl moveable by a pawl biasing member from a ratchet holding position, whereat a ratchet is maintained in a striker capture position whereat the ratchet is in latched engagement with a striker to maintain a closure panel in a closed position, to a ratchet releasing position, whereat the ratchet is moved by a ratchet biasing member to a striker release position out of latched engagement from the striker to allow the closure panel to be moved from the closed position to the open position. The power latch assembly further includes a power release actuator arranged to move a power release gear about an axis, wherein the power release gear is configured to cause the pawl to move from the ratchet holding position to the ratchet releasing position more than once during a full rotation of the power release gear about the axis.

In accordance with another aspect of the disclosure, a method of arranging actuation of a power latch assembly to move from a rest position to a release position and back to the rest position includes: providing a pawl being moveable from a ratchet holding position, whereat a ratchet is maintained in a striker capture position, whereat the ratchet is in latched engagement with a striker to maintain a closure panel in a closed position, to a ratchet releasing position, whereat the ratchet is moved to a striker release position out of latched engagement from the striker to allow the closure panel to be moved from the closed position to the open position. Further, providing a power release actuator configured to move a power release gear in a first direction to move the power latch assembly from the rest position to the release position, whereupon the pawl moves from the ratchet holding position to the ratchet releasing position, and to move the power release gear in the first direction to move the power latch assembly from the release position back to the rest position, whereupon the pawl is free to return to the ratchet holding position under a bias of a pawl biasing member.

In accordance with another aspect of the disclosure, the method includes arranging the power release gear to rotate 180 degree or less when the power latch assembly moves from the rest position to the release position and back to the rest position.

In accordance with another aspect of the disclosure, the method can further include a step of arranging the power release actuator to move the power release gear from the release position, whereat the pawl is in the ratchet releasing position, in the first direction to a snow load actuated position, whereat the pawl is prevented from returning to the ratchet holding position.

In accordance with another aspect of the disclosure, the method can further include a step of arranging the power release gear to trigger a snow load sensor to indicate when the power release gear is in the snow load actuated position.

In accordance with another aspect of the disclosure, the method can further include a step of arranging the power release actuator to move the power release gear from the snow load actuated position, in the first direction, to return the power latch assembly from the release position back to the rest position.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1A illustrates an example motor vehicle equipped with a power door actuation system situated between a front passenger swing door and a vehicle body and which is configured to include a power latch assembly in accordance with one aspect of the disclosure;

FIG. 1B is a partial perspective view showing the power latch assembly installed in a passenger swing door associated with the vehicle shown in FIG. 1A;

FIG. 2 illustrates a partially transparent side view of components of a power latch assembly arranged in accordance with an aspect of the disclosure;

FIG. 3 illustrates a perspective view of a power release gear and pawl of the power latch assembly of FIG. 2;

FIG. 4 illustrates a side view of components of the power release gear during an initial stage of release of the power latch assembly from a latched state;

FIG. 5 illustrates a view similar to FIG. 4 after continued rotation of the power release gear over about 8-10 degrees from the position of FIG. 4;

FIG. 6 illustrates a view similar to FIG. 4 after continued rotation of the power release gear over about 25 degrees from the position of FIG. 4, whereat a pawl is initially contacted by a pawl release cog fixed to the power release gear;

FIG. 7 illustrates a view similar to FIG. 4 after continued rotation of the power release gear over about 74 degrees from the position of FIG. 4, whereat a pawl is released from a ratchet of the power latch assembly, whereat a switch lever is initially contacted by a snow load cog fixed to the power release gear;

FIG. 8 illustrates a view similar to FIG. 4 after continued rotation of the power release gear over about 93 degrees from the position of FIG. 4, whereat the pawl is located in a snow load position by the pawl release cog and the power release gear stops rotating as long as the ratchet is maintained in communication with an ajar sensor;

FIG. 9 illustrates a view similar to FIG. 8, with the power release gear having continued rotation after the ratchet has moved out from communication with the ajar sensor, whereupon the pawl release cog allows the pawl to move from the snow load position;

FIG. 10 illustrates a view similar to FIG. 9, with the power release gear having continued rotation to initiate a reset of the power latch assembly, with the switch lever being held in a “no read” position;

FIG. 11 illustrates a view similar to FIG. 4 after continued rotation of the power release gear over about 108 degrees from the position of FIG. 4, whereat the pawl is released from contact with the pawl release cog and the switch lever is released from contact with the power release gear, whereupon the pawl and the switch lever return to their respective home positions under a spring bias;

FIG. 12 illustrates a view similar to FIG. 4 after continued rotation of the power release gear over about 120 degrees from the position of FIG. 4, whereat the switch lever is moved to a reset, home position, whereupon the power release gear stops rotating;

FIG. 13 is a chart illustrating a change in states of the power latch assembly as the power release gear rotates between 0 and about 121-180 degrees; and

FIG. 14 is a flow diagram illustrating a method of arranging actuation of a power latch assembly to move from a rest position to a release position and back to the rest position.

### DETAILED DESCRIPTION OF EXAMPLE EMBODIMENTS

In general, example embodiments of a power door actuation system including a power latch assembly constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

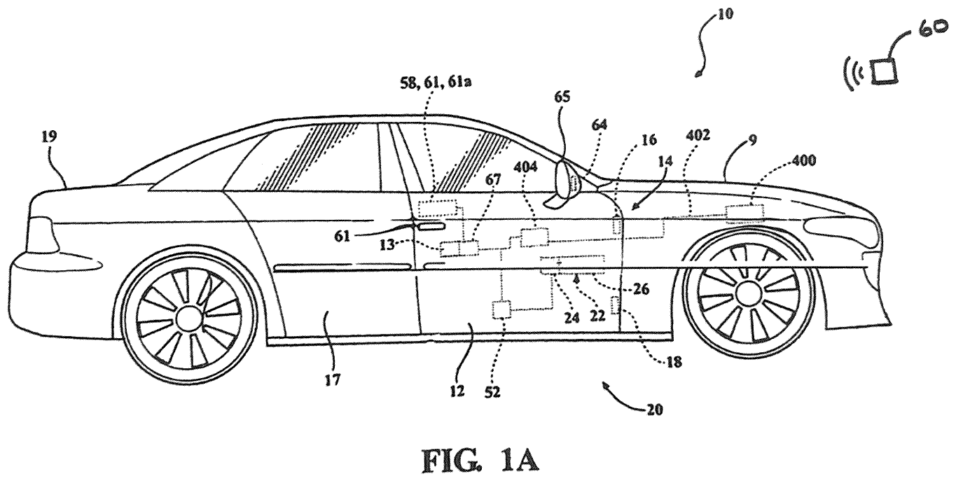

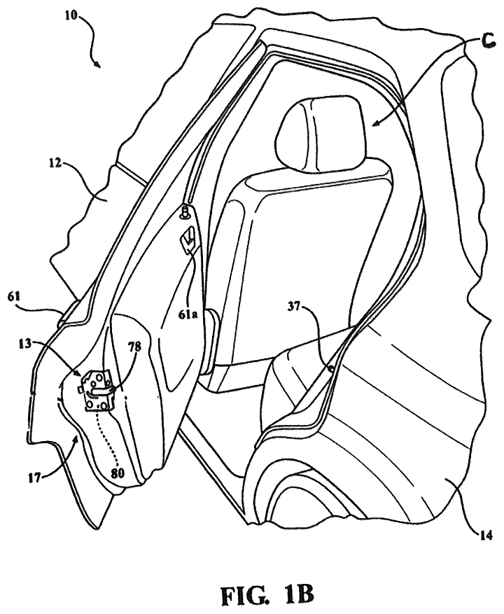

Referring initially to FIG. 1A, an example motor vehicle 10 is shown to include a first closure panel, shown by way of example and without limitation as a front passenger swing door, referred to hereafter simply as swing door or door 12, pivotally mounted to a vehicle body 14 via an upper door hinge 16 and a lower door hinge 18 which are shown in dashed lines. In accordance with the present disclosure, a power door actuation system 20 is associated with the swing door 12, and in accordance with a preferred configuration, power door actuation system 20 includes a power latch assembly 13 constructed in accordance with the disclosure, a vehicle door electric control unit (ECU) 52, and can also be configured to include a power-operated swing door actuator 22 secured within an internal cavity of passenger door 12 for coordinated control of the opening and closing of the door 12, if desired. The motor vehicle 10 illustrated in FIG. 1A may be provided including mechanically actuatable outside vehicle door handles 61 and inside door handles 61a on the vehicle door 12, if desired.

While power door actuation system 20 is only shown in FIG. 1A in association with front passenger door 12, those skilled in the art will recognize that the power door actuation system 20 and power latch assembly 13 thereof can also be associated with any other door, such as rear passenger doors 17 as shown in FIG. 1B, or also be associated with other closure panels, such as a liftgate (not shown), a hood 9, or a decklid 19. As such, while the door 12 is illustrated herein as being pivotally mounted to the vehicle body 14 for rotation relative to a vertical or generally vertical axis extending through upper and lower hinges 16, 18, it is to be recognized that the door may be configured for rotation about a horizontal axis as would be the case for a liftgate, or other offset (oblique) axis, or the like.

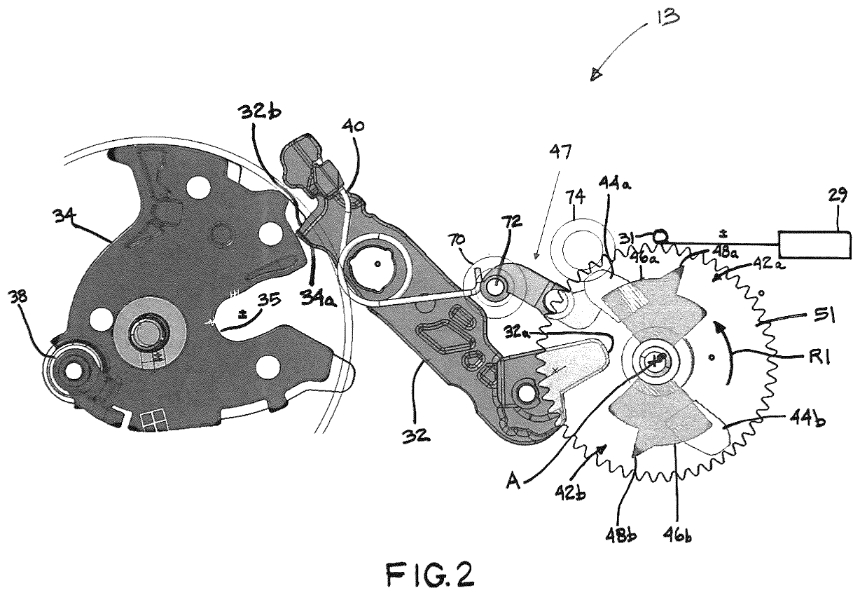

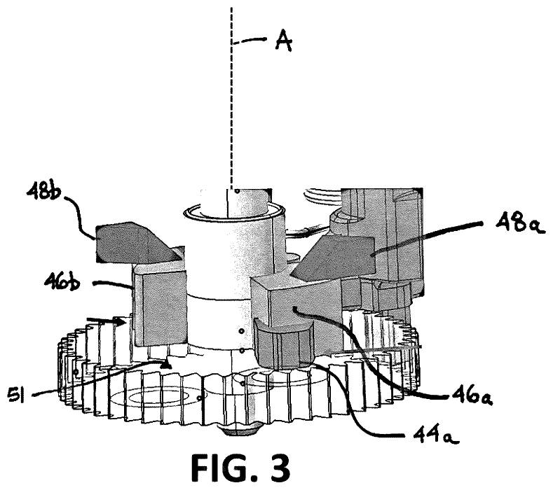

Referring to FIG. 1B, shown is a non-limiting embodiment of power latch assembly 13 for vehicle doors 12, 17 of vehicle 10. Power latch assembly 13 can be positioned on vehicle door(s) 12, 17 and arranged in a suitable orientation to engage and retain a striker 37, mounted on vehicle body 14, when door 12, 17 is closed. Power latch assembly 13 includes parts as enumerated in FIG. 2, and a power release actuator 29 for controlling powered actuation of a latch release mechanism. Power release actuator 29 is shown schematically, and can include an electric motor configured to drive a gear 31, such as a worm gear, by way of example and without limitation, arranged in meshed engagement with a power release gear 51. Power release gear 51 is configured to operably move a pawl 32 from a ratchet holding position, whereat pawl 32 maintains a ratchet 34 in a primary striker capture position, whereat striker 37 is captured in a striker slot 35 of ratchet to releasably maintain door 12 in a fully closed position. Ratchet 34 may be configured for movement between two striker capture positions, if desired, including the primary striker capture position, also referred to as fully closed position, and a secondary striker capture position, also referred to as partially closed position, whereat ratchet 34 retains striker 37 against being fully released. Ratchet 34 is also moveable to a striker release position, whereat ratchet 34 permits the release of striker 37 from the striker slot 35 and from a fishmouth 78 (FIG. 1B) provided by a latch housing, also referred to as frame plate 80, of power latch assembly 13. A ratchet biasing member 38, such as a spring, is provided to normally bias ratchet 34 toward its striker release position.

Pawl 32 is movable between at least one ratchet holding position (FIG. 2) whereat pawl 32 holds ratchet 34 in its closed, striker capture position(s), wherein door 12 is maintained in a closed state, also referred to as closed position, thereby being restrained against being fully opened, and a ratchet releasing position (FIG. 7) whereat pawl 32 permits ratchet 34 to move to its open, striker release position, wherein door 12 can be moved to a fully open state, also referred to as open position. A pawl biasing member 40, such as a suitable spring, is provided to normally bias pawl 32 toward its ratchet holding position.

Power release actuator 29 can be used as part of a conventional passive keyless entry feature. When a person approaches vehicle 10 with an electronic key fob 60 (shown schematically in FIG. 1A) and actuates the outside door handle 61, for example, sensing both the presence of key fob 60 and that door handle 61 has been actuated (e.g. via communication between a switch (not shown) and a latch electronic control unit (ECU) shown at 67 (FIG. 1A) that at least partially controls the operation of power latch assembly 13. In turn, latch ECU 67 signals and actuates power release actuator 29 to cause the latch release mechanism, via driven rotation of power release gear 51 in a first direction (R1; shown as being counterclockwise in FIG. 2), to pivot pawl 32 to its ratchet releasing position to release ratchet 34, whereupon ratchet 34 moves under the bias of ratchet biasing member 40 to its striker release position and shift power latch assembly 13 into its unlatched operating state so as to facilitate subsequent opening of swing door 12. Power release actuator 29 can be alternatively activated as part of a proximity sensor based entry feature (radar based proximity detection for example), for example when a person approaches vehicle 10 with electronic key fob 60 and actuates a proximity sensor 58, such as a capacitive sensor, or other touch/touchless based sensor (based on a recognition of the proximity of an object, such as the touch/swipe/hover/gesture or a hand or finger, or the like), (e.g. via communication between the proximity sensor 58 (FIG. 1A) and latch ECU 67 (FIG. 1A) that at least partially controls the operation of closure latch assembly 13). In turn, latch ECU 67 signals power release actuator 29 to cause the latch release mechanism to release the latch mechanism and shift power latch assembly 13 into its unlatched operating state to facilitate subsequent opening of vehicle door 12. Also, power release actuator 29 can be used in coordinated operation with power-operated swing door actuator 22. Further yet, outside door handle 61 may be configured for mechanical actuation of power latch assembly 13 to facilitate opening the swing door 12, as will be understood by a person possessing ordinary skill in the art of latches, such as, by way of example and without limitation, during power interruption and/or upon experiencing a crash condition, as discussed further below.

The inside door handle 61a, located on an interior facing side of the door 12 facing the inside of the passenger compartment C may signal latch ECU 67 for opening the door 12 (e.g. including unlocking and opening the power latch assembly 13, as well as commanding operation of the power-operated swing door actuator 22). This opening lever or inside door handle 61a can trigger a switch 63a connected operably to the latch ECU 67 such that, when the switch 63a is actuated, the latch ECU 67 signals and facilitates power latch assembly 13 being activated. Subsequently, the latch ECU 67 may facilitate that the power-operated swing door actuator 22 is activated (i.e. an extension member 26 is deployed or extended) to continue the automatic opening of door 12. In the alternative, the power-operated swing door actuator 22 may be powered on at a point before the final presentment position is reached so as to provide a seamless transition between the two stages of door opening (i.e. both motors are overlapping in operation for a short time period). Alternatively, the latch ECU 67 may facilitate that the power-operated swing door actuator 22 is operated as a door check (i.e. the extension member 26 is deployed or extended and maintained at such a deployed or extended condition) until the user manually takes control of the swing door 12 to further open it to a fully opened position. Further yet, inside door handle 61a may be configured for mechanical actuation of power latch assembly 13, via intervening mechanical mechanism(s), to facilitate opening the swing door 12, as will be understood by a person possessing ordinary skill in the art of latches, such as during power interruption and/or upon experiencing a crash condition, as discussed further below.

Now referring back to FIG. 1A, the power door actuation system 20 and the power latch assembly 13 are electrically connected to a main power source 400 of the motor vehicle 10, for example a main battery providing a battery voltage V_{batt} of 12 V, through an electrical connection element 402, for example a power cable (the main power source 400 may equally include a different source of electrical energy within the motor vehicle 10, for example an alternator). The electronic latch ECU 67 and/or swing door ECU 52 are also coupled to the main power source 400 of the motor vehicle 10, so as to receive the battery voltage V_{batt}; the electronic latch ECU 67 and/or swing door ECU 52 are thus able to check if the value of the battery voltage V_{batt} decreases below a predetermined threshold value, to promptly determine if an emergency condition (when a backup energy source may be needed) occurs.

As shown in the schematic block diagram of FIG. 1A, a backup energy source 404, which may be integrated forming part of an electronic control circuit of the electronic latch ECU 67 and/or swing door ECU 52, or may be separate therefrom, is configured to supply electrical energy to the power door actuation system 20 and/or the power latch assembly 13, and to the same electronic control circuit of the electronic latch ECU 67 and/or swing door ECU 52, in case of failure or interruption of the main power supply from the main power source 400 of the motor vehicle 10.

In an illustrative example, the backup energy source 404 includes a group of low voltage supercapacitors (not shown) as an energy supply unit (or energy tank) to provide power backup to the power door actuation system 20 and/or the power latch assembly 13, even in case of power failures. Supercapacitors may include electrolytic double layer capacitors, pseudocapacitors or a combination thereof. Other electronic components and interconnections of a backup energy source 404, such as a boost module to increase the voltage from the backup energy source 404 to an actuator, such as the power-operated swing door actuator for example, are disclosed in co-owned patent application US2015/0330116, which is incorporated herein by way of reference in its entirety.

Swing door ECU 52 can also receive an additional input from a proximity sensor 64 (e.g. ultrasonic or radar) positioned on a portion of swing door 12, such as on a door mirror 65, or the like, as shown in FIG. 1A. Proximity sensor 64 assesses if an obstacle, such as another car, tree, post, or otherwise, is near or in close proximity to vehicle door 12. If such an obstacle is present, proximity sensor 64 will send a signal to swing door ECU 52, and swing door ECU 52 will proceed to turn off an electric motor 24 of power operated swing door actuator 22 to stop movement of swing door 12, and thus prevent vehicle door 12 from hitting the obstacle.

The power latch assembly 13 is fully operational via actuation of power release actuator 29 and corresponding movement of the power release gear 51 in a single rotational direction, discussed above as the first direction R1. Accordingly, the direction of powered movement of power release actuator 29 and power release gear 51 driven thereby is monodirectional, also referred to as unidirectional. As such, there is no need for reverse, bi-directional movement of power release actuator 29 and power release gear 51 to effect full operation of power latch assembly 13, including release and reset of power latch assembly 13. As such, as discussed further below, highly efficient operation is provided by power latch assembly 13, with minimal generation of noise, which typically occurs in latch assemblies requiring reverse, bi-directional rotation of a corresponding power release actuator and power release gear driven thereby. As there is no powered change in direction of the power release actuator 29, or no reversal of operation of the power release actuator 29, correspondingly no motor reversal circuitry (for example an H-Bridge) and control/sensing to coordinate such motor reversal circuity is required, thereby reducing the electronic complexity and costs. Furthermore, no manual change in direction of the power release actuator 29, such as for example by use of a reset spring or bias, is required to return the power release actuator 29 to a home or reset position, thereby eliminating the additional cost of a component and eliminating noise associated with such as reset spring causing components to impact upon return to their home/reset positions.

Power release gear 51 is illustrated having a pair of cog members, including a first cog member 42a and a second cog member 42b, with the first and second cog members 42a, 42b extending radially outwardly from a rotational axis A of the power release gear 51 in circumferentially spaced relation from one another, shown as being diametrically opposite relation from one another, by way of example and without limitation. First and second cog members 42a, 42b extend laterally outwardly in fixed relation from a common planar side 54 of power release gear 51. First and second cog members 42a, 42b can be formed as a monolithic piece of material with power release gear 51, or formed as separate pieces of material and subsequently fixed to the side 54 of power release gear 51, if desired. In the non-limiting embodiment, first and second cog members 42a, 42b are identical with one another, having the same size and shaped features, thus, being able to perform the same operations, though at different times and during separate actuations of power latch assembly 13. Stated another way, first cog member 42a performs a first desired operation of latch assembly 13 upon actuation of power latch assembly 13 in a first select command via rotation of power release gear 51 in the first direction R1, while second cog member 42b performs a second desired operation of latch assembly 13 upon actuation of power latch assembly 13 in a second select command of latch assembly 13 via rotation of power release gear 51 in the first direction R1. Accordingly, as noted above, operation of power latch assembly 13, including movement from a closed position, whereat the ratchet 34 is in latched engagement with striker 37 to maintain door 12 in a closed position, to a ratchet releasing position, whereat the ratchet 34 is moved to a striker release position out of latched engagement from the striker 37 to allow door 12 to be moved from the closed position to the open position, and including a snow load position, whereat pawl 32 is prevented from returning to the ratchet holding position while ratchet 34 is in its striker release position, and back to a reset state, whereat pawl 32 is returned under the bias of pawl biasing member 40 for engagement with ratchet 34, and eventual return to the ratchet holding position, does not require movement of the power release gear 51 in a direction opposite R1. It is to be further understood that a single one of the first and second cog members 42a, 42b is configured to effect full operation of power latch assembly 13 from a closed position to the open position and for return from the open position to the closed position. As such, with first and second cog members 42a, 42b being diametrically opposite one another (180 degrees opposite one another), full operation of power latch assembly 13 can be attained via rotation of power release gear 51 over 180 degrees or less. Accordingly, minimal movement of power release gear 51 in a single rotational direction R1 is needed to perform a desired actuation of power latch assembly 13.

The first and second cog members 42a, 42b have a respective first and second pawl release cogs, referred to hereafter as first and second pawl cogs 44a, 44b, arranged for selective engagement with one end 32a of pawl 32, a respective first and second switch cog 46a, 46b arranged for selective engagement with a switch lever 47, and a first and second snow load cog 48a, 48b for selective engagement with the switch lever 47, during rotation of power release gear 51 in the first direction R1. The first and second pawl cogs 44a, 44b are laterally offset along a direction of axis A from the respective first and second switch cogs 46a, 46b and the respective first and second snow load cogs 48a, 48b, wherein the first and second switch cogs 46a, 46b and the respective first and second snow load cogs 48a, 48b are laterally aligned with one another. The first and second snow load cogs 48a, 48b extend radially outwardly from the respective first and second switch cogs 46a, 46b.

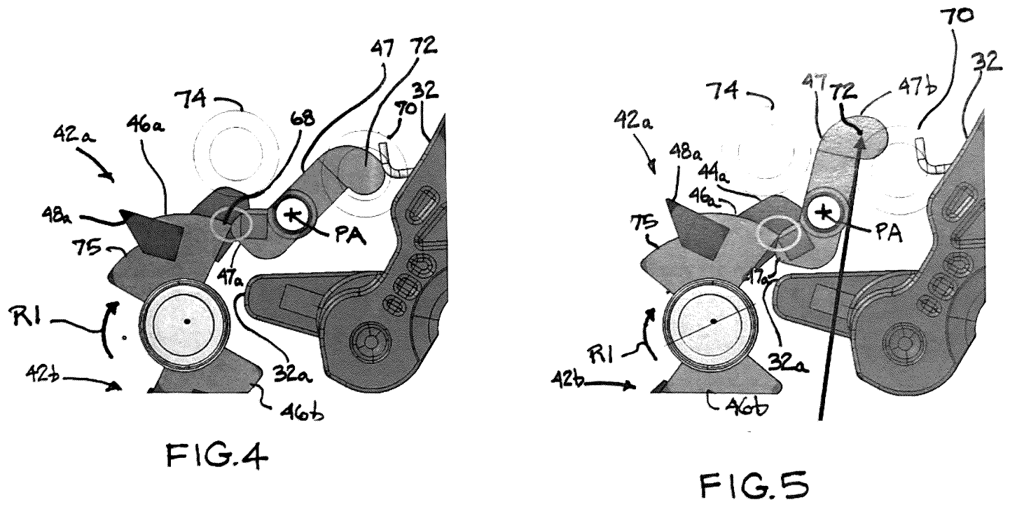

With reference to FIG. 4, power latch assembly 13 is illustrated during an initial stage of release from a closed, latched position. Power release actuator 29 drives power release gear 51 in the first direction R1, whereupon a nose 68 of first switch cog 46a is moved concurrently in fixed relation with power release gear 51 into engagement with a first end 47a of switch lever 47, thereby causing switch lever 47 to begin pivotal movement about a generally central pivot axis PA. During this initial stage, pawl 32 remains free from engagement from first cog member 42a and remains in its ratchet holding position. As shown in FIG. 5, after continued rotation of power release gear 51, such as between about 6-10 degrees rotation of the power release gear 51, in the first direction R1, the switch lever 47 is rotated counterclockwise about the central pivot axis PA by the first switch cog 46a, whereupon a reset sensor 70 loses communication with a magnet 72 in a second end 47b of switch lever 47. During this stage, pawl 32 remains free from engagement from first cog member 42a and remains in its ratchet holding position.

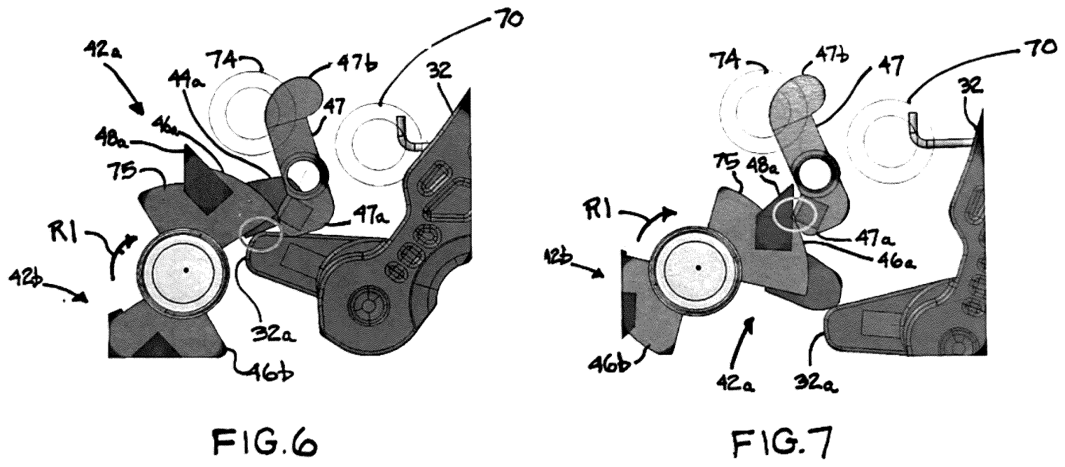

With reference to FIG. 6, after about 25 degrees rotation of the power release gear 51 in the first direction R1, the end 32a of pawl 32 is initially engaged by first pawl cog 44a. Power release gear 51 continues rotation in the first direction R1, and then, after rotation between about 25-74 degrees (FIG. 7), a lock surface 32b (FIG. 2) of pawl 32 is removed from engagement with a primary locking surface 34a of ratchet 34, whereupon ratchet 34 is free to move under the bias of ratchet biasing member 38 to one of a secondary locking position or a striker release position, and, first snow load cog 48a initiates contact with switch lever 47.

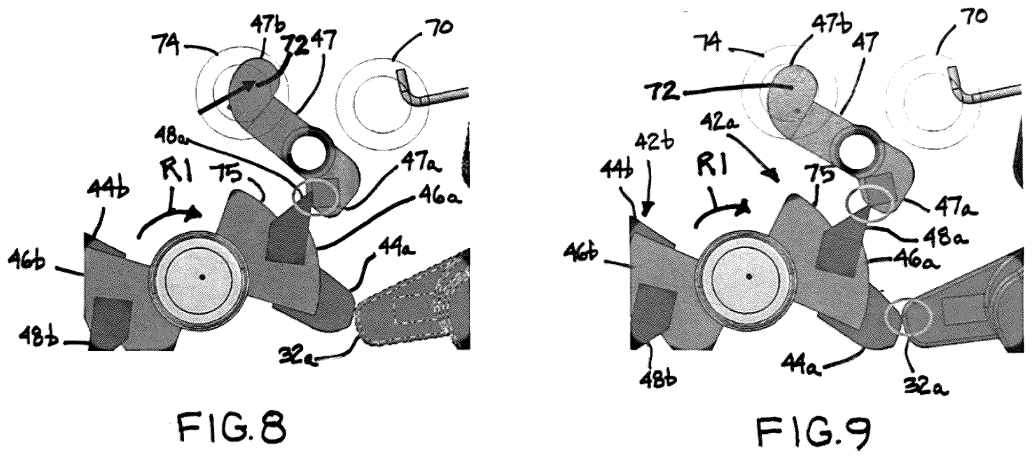

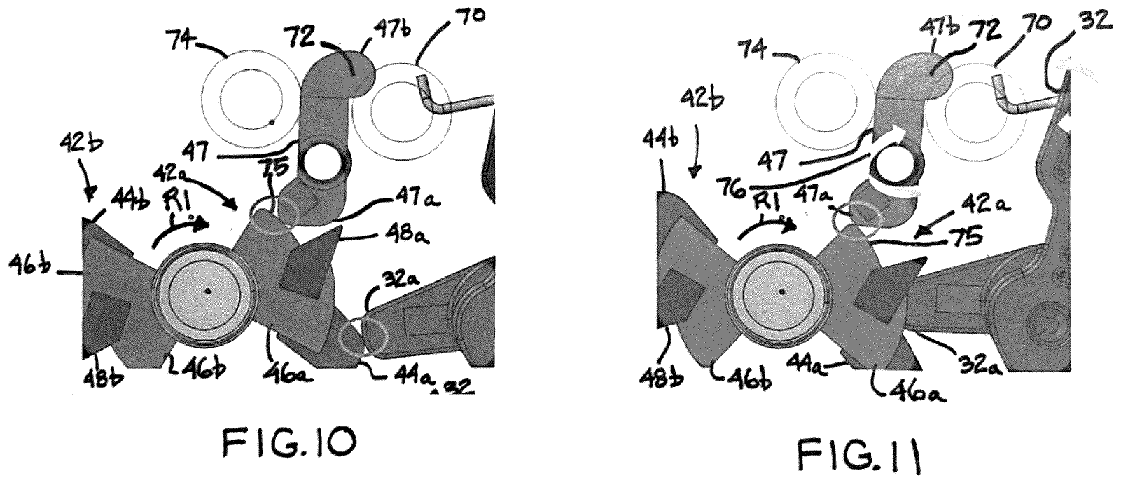

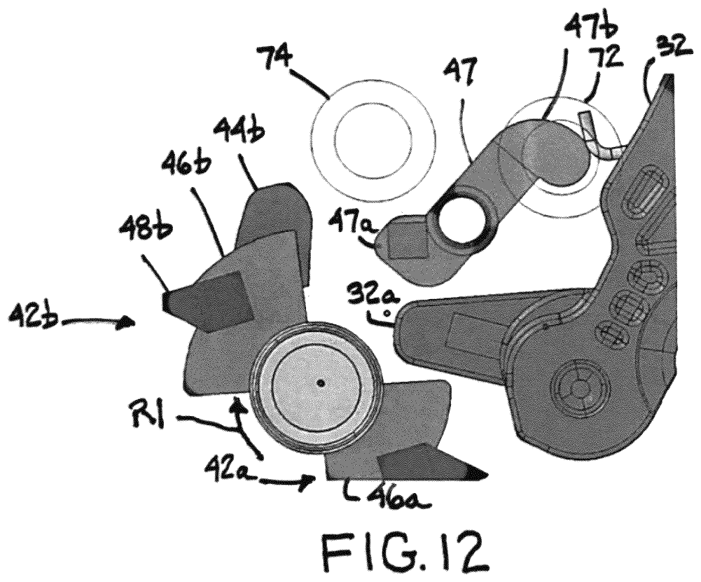

With reference to FIG. 8, after about 73-80 degrees to 93 degrees of continued rotation of the power release gear 51 from the rest position in the first direction R1, pawl 32 is held in a snow load position by first pawl cog 44a, whereat first snow load cog 48a pivots switch lever 47 to bring magnet 72, fixed to second end 47b of switch lever 47, into sensing communication with a snow load sensor 74. While in this position, if ratchet 34 is not moved out of communication with an ajar sensor, power release actuator 29 is deactivated, thereby stopping movement of power release gear 51 in the first direction R1 until ratchet 34 is moved out from communication with ajar sensor. Upon movement of ratchet 34 out from sensing communication with ajar sensor, as shown in FIG. 9, power release actuator 29 continues to drive power release gear 51 in the first direction R1 past the snow load position, whereat first pawl cog 44a begins to move out from contact from the end 32a of pawl 32, while first snow load cog 48a is moved beyond and out of contact with the first end 47a of switch lever 47 to initiate a reset of power latch assembly 13 (FIG. 10). During initiation of the reset, end 47a of switch lever 47 moves along a surface 75 of first switch cog 46a, whereupon switch lever 47 is held in a “no read” condition, whereat magnet 72 is positioned between and out from sensing communication with the snow load sensor 74 and the reset sensor 70.

With reference to FIG. 11, after about 108 degrees rotation of the power release gear 51 in the first direction R1, pawl 32 loses contact with first pawl cog 44a and switch lever 47 loses contact with first switch cog 46a. Then, as power release gear 51 continues rotating between about 108-120 degrees, as shown in FIG. 12, pawl 32 is free to return to its home position under the bias of pawl biasing member 40 into engagement with ratchet 34, while switch lever 47 is free to move to its reset position under a bias imparted by a switch lever biasing member 76 (FIG. 11), such as a spring, whereat magnet 72 is brought into sensing communication with reset sensor 70. Accordingly, power latch assembly 13 completes a release and reset operation with power release gear 51 rotating solely in the first direction R1 over 180 degrees or less. Upon being reset, power release actuator 29 of power latch assembly 13 is ready to be actuated again, when desired, to perform the desired operation with second cog member 42b, whereupon power release gear 51 will be driven in the first direction R1 in the same fashion as discussed above for the first actuation of power release actuator 29, and thus, repetition of such movement is unnecessary. Then, after performing the desired function with second cog member 42b via rotation of power release gear 51 over 180 degrees or less, the first cog member 42a is automatically moved into position to perform the next desired function via another actuation of power release actuator 29 causing rotation of power release gear 51 in the first direction R1. Thus, it is to be understood that power release actuator 29 and power release gear 51 are unidirectional to perform all functions of power latch assembly 13, such that power release gear 51 only rotates unidirectional in the first direction R1 to perform all functions of power latch assembly 13.

In accordance with a further aspect, power release gear 51 is customizable to include three cog members 42a, 42b, and a third cog member (not shown), such that rather than two separate release/reset operations being performed in one full rotation of power release gear 51 over 360 degrees, three separate release/reset operations can be performed in one full rotation of power release gear 51 over 360 degrees. Accordingly, rather than having diametrically opposite cog members 42a, 42b spaced 180 degrees circumferentially from one another, the three cog members 42a, 42b, (third not shown) can be spaced 120 degrees circumferentially from one another.

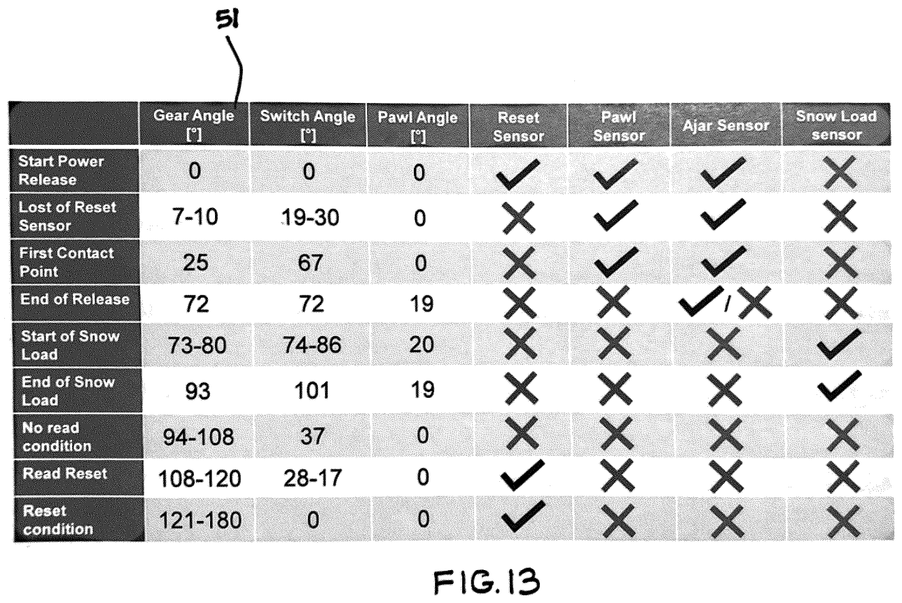

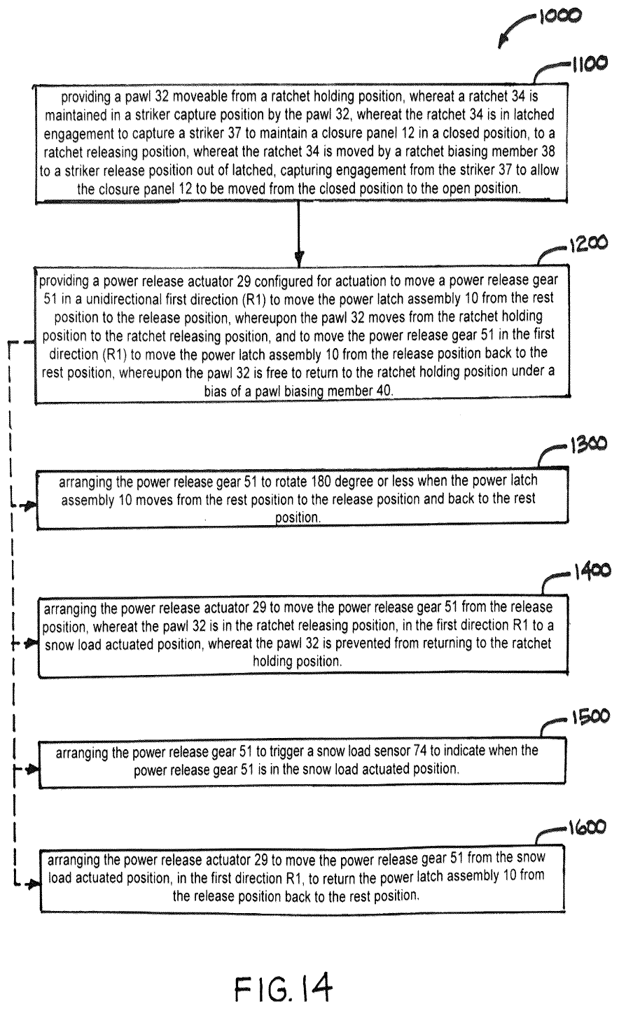

In FIG. 13, a chart showing a change in states of the power latch assembly 13, along with rotational angles of various components and states of various sensors as the power release gear 51 rotates between 0 and about 121-180 degrees is illustrated.

In accordance with another aspect of the disclosure, as illustrated in FIG. 14, a method 1000 of arranging actuation of a power latch assembly 13 to move from a rest position to a release position and back to the rest position is provided. The method 1000 includes a step 1100 of providing a pawl 32 being moveable from a ratchet holding position, whereat a ratchet 34 is maintained in a striker capture position by the pawl 32, whereat the ratchet 34 is in latched engagement to capture a striker 37 to maintain a closure panel 12 in a closed position, to a ratchet releasing position, whereat the ratchet 34 is moved by a ratchet biasing member 38 to a striker release position out of latched, capturing engagement from the striker 37 to allow the closure panel 12 to be moved from the closed position to the open position. Further, a step 1200 of providing a power release actuator 29 configured for actuation to move a power release gear 51 in a unidirectional first direction (R1) to move the power latch assembly 10 from the rest position to the release position, whereupon the pawl 32 moves from the ratchet holding position to the ratchet releasing position, and to move the power release gear 51 in the first direction (R1) to move the power latch assembly 10 from the release position back to the rest position, whereupon the pawl 32 is free to return to the ratchet holding position under a bias of a pawl biasing member 40.

In accordance with a further aspect, the method 1000 further includes a step 1300 of arranging the power release gear 51 to rotate 180 degree or less when the power latch assembly 10 moves from the rest position to the release position and back to the rest position.

In accordance with a further aspect, the method 1000 can further include a step 1400 of arranging the power release actuator 29 to move the power release gear 51 from the release position, whereat the pawl 32 is in the ratchet releasing position, in the first direction R1 to a snow load actuated position, whereat the pawl 32 is prevented from returning to the ratchet holding position.

In accordance with a further aspect, the method 1000 can further include a step 1500 of arranging the power release gear 51 to trigger a snow load sensor 74 to indicate when the power release gear 51 is in the snow load actuated position.

In accordance with a further aspect, the method 1000 can further include a step 1600 of arranging the power release actuator 29 to move the power release gear 51 from the snow load actuated position, in the first direction R1, to return the power latch assembly 10 from the release position back to the rest position.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a closure panel of a motor vehicle, comprising:
a pawl moveable from a ratchet holding position, whereat a ratchet is maintained in a striker capture position, whereat the ratchet is in latched engagement with a striker to maintain the closure panel in a closed position, to a ratchet releasing position, whereat the ratchet is moved to a striker release position out of latched engagement from the striker to allow the closure panel to be moved from the closed position to an open position; and
a power release actuator arranged to move a power release gear from a rest position, whereat the pawl is in the ratchet holding position, in a first direction to a first release actuated position, whereat the pawl is moved to the ratchet releasing position, and to move the power release gear from the first release actuated position in the first direction to a first reset actuated position, whereat the pawl is free to return to the ratchet holding position.

2. The power latch assembly of claim 1, wherein the power release gear moves in the first direction about 180 degrees or less from the rest position to the first reset actuated position.

3. The power latch assembly of claim 2, wherein the power release actuator is arranged to move the power release gear from the first reset actuated position, whereat the pawl is in the ratchet holding position, in the first direction to a second release actuated position, whereat the pawl is moved to the ratchet releasing position.

4. The power latch assembly of claim 3, wherein the power release gear has a first pawl release cog configured to engage the pawl when in the first release actuated position and a second pawl release cog configured to engage the pawl when in the second release actuated position, wherein the first pawl release cog and the second pawl release cog are circumferentially offset from one another.

5. The power latch assembly of claim 3, wherein the power release actuator is arranged to move the power release gear from the first release actuated position, in the first direction, to a first snow load actuated position, whereat the pawl is prevented from returning to said ratchet holding position.

6. The power latch assembly of claim 5, wherein the power release gear is configured to trigger a first snow load sensor to indicate when the power release gear is in the first snow load actuated position.

7. The power latch assembly of claim 5, wherein the power release actuator is arranged to move the power release gear from the first snow load actuated position, in the first direction, to the first reset actuated position.

8. The power latch assembly of claim 7, wherein the power release actuator is arranged to move the power release gear from the second release actuated position, in the first direction, to a second reset actuated position, whereat the pawl is free to return to the ratchet holding position.

9. The power latch assembly of claim 8, wherein the power release actuator is arranged to move the power release gear from the second release actuated position, in the first direction, to a second snow load actuated position, whereat the pawl is prevented from returning to said ratchet holding position.

10. The power latch assembly of claim 9, wherein the power release gear is configured to trigger a second snow load sensor to indicate when the power release gear is in the second snow load actuated position.

11. A power latch assembly for a motor vehicle, comprising:
a pawl moveable by a pawl biasing member from a ratchet holding position, whereat a ratchet is maintained in a striker capture position whereat the ratchet is in latched engagement with a striker to maintain a closure panel in a closed position, to a ratchet releasing position, whereat the ratchet is moved by a ratchet biasing member to a striker release position out of latched engagement from the striker to allow the closure panel to be moved from the closed position to the open position; and
a power release actuator arranged to move a power release gear about an axis, wherein the power release gear is configured to cause the pawl to move from the ratchet holding position to the ratchet releasing position more than once during a full rotation of the power release gear about the axis.

12. The power latch assembly of claim 11, wherein the power release gear is configured to rotate in a single direction about the axis over 180 degrees or less, whereupon the pawl is caused to move from the ratchet holding position to the ratchet releasing position and back to the ratchet holding position.

13. The power latch assembly of claim 12, wherein the power release actuator is arranged to move the power release gear from a first release actuated position, whereat the pawl is in the ratchet releasing position, in the first direction to a first snow load actuated position, whereat the pawl is prevented from returning to the ratchet holding position.

14. The power latch assembly of claim 12, wherein the power release gear is configured to cause the pawl to move from the ratchet holding position to the ratchet releasing position during rotation of the power release gear over less than 180 degrees about the axis.

15. The power latch assembly of claim 14, wherein the power release gear has a first pawl release cog and a second pawl release cog spaced circumferentially from one another, wherein the first pawl release cog is configured to engage the pawl to cause the pawl to move from the ratchet holding position to the ratchet releasing position during a first actuation of the power release actuator and the second pawl release cog is configured to engage the pawl to cause the pawl to move from the ratchet holding position to the ratchet releasing position during a second actuation of the power release actuator.

16. A method of arranging actuation of a power latch assembly to move from a rest position to a release position and back to the rest position, comprising:
providing a pawl being moveable from a ratchet holding position, whereat a ratchet is maintained in a striker capture position whereat the ratchet is in latched engagement with a striker to maintain a closure panel in a closed position, to a ratchet releasing position, whereat the ratchet is moved by a ratchet biasing member to a striker release position out of latched engagement from the striker to allow the closure panel to be moved from the closed position to the open position;
providing a power release actuator configured to move a power release gear in a first direction to move the power latch assembly from the rest position to the release position, whereupon the pawl moves from the ratchet holding position to the ratchet releasing position, and to move the power release gear in the first direction to move the power latch assembly from the release position back to the rest position, whereupon the pawl is free to return to the ratchet holding position under a bias of a pawl biasing member.

17. The method of claim 16, further including arranging the power release gear to rotate 180 degree or less when the power latch assembly moves from the rest position to the release position and back to the rest position.

18. The method of claim 16, further including arranging the power release actuator to move the power release gear from the release position, whereat the pawl is in the ratchet releasing position, in the first direction to a snow load actuated position, whereat the pawl is prevented from returning to the ratchet holding position.

19. The method of claim 18, further including arranging the power release gear to trigger a snow load sensor to indicate when the power release gear is in the snow load actuated position.

20. The method of claim 19, further including arranging the power release actuator to move the power release gear from the snow load actuated position, in the first direction, to return the power latch assembly from the release position back to the rest position.
